(19) United States
(12) Patent Application Publication
(10) Pub. No.: US 2003/0125175 A1
(43) Pub. Date: Jul. 3, 2003

(54) Automatic tool changer for machine tool

(75) Inventor: Myung Kook Seo, Masan-si (KR)

Correspondence Address: STAAS & HALSEY LLP, 700 11TH STREET, NW, SUITE 500, WASHINGTON, DC, 20001, US

(73) Assignee: DAEWOO HEAVY INDUSTRIES & MACHINERY LTD., Incheon (KR)

(21) Appl. No.: 10/330,343

(22) Filed: Dec. 30, 2002

(30) Foreign Application Priority Data
Dec. 31, 2001 (KR) 2001-88940

(51) Int. Cl. B23Q 3/157

(52) U.S. Cl. 483/55

(57) ABSTRACT

An automatic tool changer for machine tool comprises a machine frame with a changer frame portion, and a spindle rotatably attached to the machine frame and adapted to removably grip a tool in position. An up-down carriage is mounted to the changer frame portion of the machine frame for elevational movement between a raised position and a lowered position. A magazine carriage is laterally movably mounted to the up-down carriage for movement between a home position far away from the spindle and an operative position close to the spindle. A tool storage magazine is carried by the magazine carriage and has a plurality of tool holders for changeably holding different kinds of tools. A vertical magazine actuator serves to cause the up-down carriage, the magazine carriage and the tool storage magazine to move in a vertical direction. A horizontal magazine actuator is adapted to cause the magazine carriage and the tool storage magazine to move in a horizontal direction.

### BACKGROUND OF THE INVENTION

1. Field of the Invention

The present invention is generally directed to automatic tool changers for use in a machine tool and, more specifically, to an automatic tool changer capable of assuring that a tool can be changed by way of elevational and lateral movement of a tool storage magazine without having to use a tool change arm and with no need to cause positive movement of the spindle itself.

2. Description of the Prior Art

It is a knowledge of public domain that a tool should be changed frequently in order to have a workpiece cut into a desired configuration by use of such machine tools as a computerized numerical control lathe and a machining center. Also highly conventional is that automatic tool changers are employed in the machine tools to accomplish the tool changing operation in a fully automated fashion.

There are many different automatic tool changers known in the art, most of which make use of a changer arm that can be caused to rotate in a predetermined sequence to thereby bring a given tool in a tool storage magazine into engagement with a spindle and return a used tool in the spindle back to the storage magazine. In the recent years, armless automatic tool changers that include no changer arm have been developed and have become commercially available.

As one example of armless automatic tool changers, U.S. Pat. No. 5,300,006 to Tanaka et al. teaches a machine tool having an automatic tool changer including a single drive motor for rotation and lateral movement of a tool storage magazine of the automatic tool changer. The single drive motor is connected to a transmission for selectively moving the magazine between a withdrawn storage position and an advanced position whereby a selected tool holder may be brought into engagement with the spindle. A carriage frame supports the magazine on a trackway for lateral movement and a track gear extends parallel to the trackway. A speed reducer is connected to the drive motor and has an output shaft that supports a pinion gear positioned to engage the rack and a casing that is connected to the magazine. A locking pin is mounted to the carriage frame for selected movement between a first position wherein the magazine is locked and the rotation of the output shaft causes the carriage frame and magazine to advance along the trackway and a second position wherein the output shaft is locked and the rotation of the casing causes the magazine to rotate.

According to the prior art tool changer referred to just above, the spindle has to be moved upwardly and downwardly in the process of tool changing operation, which would inevitably increase the overall length of a machine tool column. This may in turn become a major culprit in making the packaging, transportation and installation of the machine tool cumbersome and difficulty. This type of tool changer poses another drawback in that the degree of precision in cutting a workpiece may be adversly affected by the movability of the spindle.

### SUMMARY OF THE INVENTION

Accordingly, it is an object of the present invention to provide an automatic tool changer for machine tool capable of accomplishing the tool changing operation without having to use any tool change arm and with no need to cause movement of the spindle.

Another object of the invention is to provide an automatic tool changer for machine tool that can help reduce the overall length of a machine column while assuring an increased degree of precision in cutting a workpiece into a desired size and shape.

With this object in view, there is provided an automatic tool changer for machine tool, comprising: a machine frame with a changer frame portion; a spindle rotatably attached to the machine frame and adapted to removably hold a tool in position; an up-down carriage mounted to the changer frame portion of the machine frame for elevational movement between a raised position and a lowered position; a magazine carriage laterally movably mounted to the up-down carriage for movement between a home position far away from the spindle and an operative position close to the spindle; a tool storage magazine carried by the magazine carriage and having a plurality of tool holders for changeably holding different kinds of tools; a vertical magazine actuator for causing the up-down carriage, the magazine carriage and the tool storage magazine to move as a unit in a generally vertical direction in such a manner that one of the tools can be either brought into engagement with the spindle or removed from the spindle; and a horizontal magazine actuator for causing the magazine carriage and the tool storage magazine to move in a generally horizontal direction toward or away from the spindle so that one of the tool holders can either grasp or release the tool in the spindle.

### BRIEF DESCRIPTION OF THE DRAWINGS

The above and other objects, features and advantages of the present invention will be more apparent from the following detailed description taken in conjunction with the accompanying drawings, in which:

FIG. 1 is a front elevational, partially sectional view showing an automatic tool changer for machine tool according to the present invention;

FIG. 2 is a top view best illustrating a plurality of radially arranged tool holders employed in a tool storage magazine of the automatic tool changer according to the present invention;

FIG. 3 is a side elevational view clearly depicting an electric motor and a geneva mechanism both employed to intermittently rotate the tool storage magazine; and

FIGS. 4A through 4D show a number of operational steps of the inventive tool changer, namly, causing a tool holder to grasp a used tool in a spindle, removing the used tool from the spindle, bringing a new tool into engagement with the spindle and retracting the tool holder to set free the new tool in the spindle.

### DETAILED DESCRIPTION OF THE PREFERRED EMBODIMENT

A preferred embodiment of the invention will now be described with reference to the accompanying drawings.

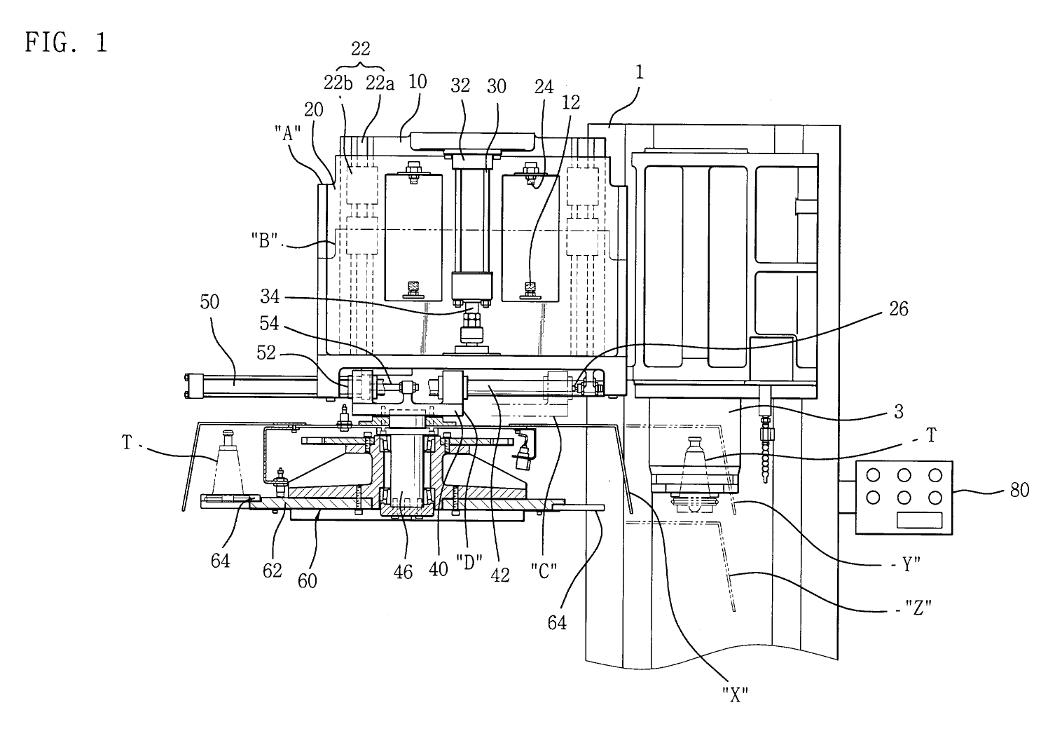

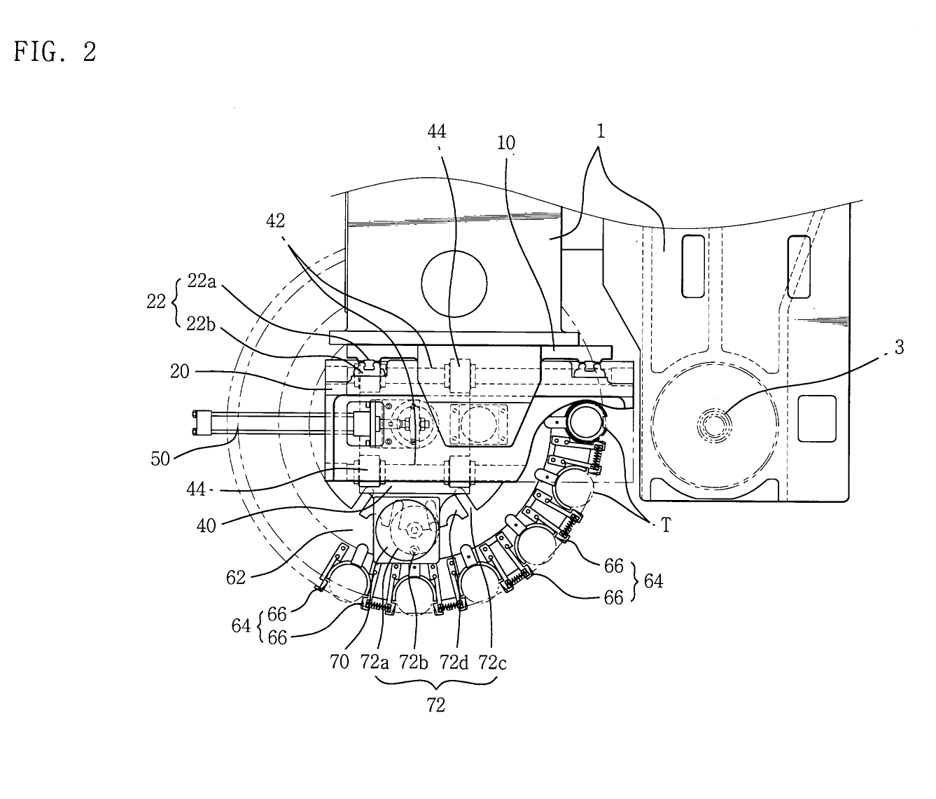

Referring first to FIGS. 1 and 2, an automatic tool changer for machine tool includes a machine frame 1 having a changer frame portion 10 at one side thereof with an ample spacing left from the ground. A spindle 3 is rotatably provided to the top of the machine frame 1 and adapted to removably grip a selected one of cutting tools in position.

An up-down carriage 20 is mounted to the changer frame portion 10 of the machine frame 1 for elevational sliding movement along the changer frame portion 10. The elevational movement of the up-down carriage 20 is performed by virtue of a vertical magazine actuator 30. The up-down carriage 20 is of generally rectangular shape and can be moved between a raised top position “A” as indicated in solid lines and a lowered bottom position “B” as illustrated in phantom lines in FIG. 1.

It will be noted that a pair of linear motion guides 22 are provided at the sliding inerface of the changer frame portion 10 and the up-down carriage 20 to help elevational movement of the up-down carriage 20. Each of the linear motion guides 22 is composed of a guide rail 22a secured to the changer frame portion 10 and a slider 22b affixed to the the up-down carriage 20.

Preferably, the vertical magazine actuator 30 is a pneumatic cylinder and has to a cylinder housing 32 and a cylinder rod 34 extendibly fitted with each other. The cylinder housing 32 is fixedly mounted to the changer frame portion 10 whereas the cylinder rod 34 is connected to the up-down carriage 20 at its free end. The vertical magazine actuator 30 can be subjected to extending and retracting movement to thereby bring the up-down carriage 20 into the raised position “A” and the lowered position “B”.

According to the inventive tool changer, a descending movement restrictor means is provided that serves to determine the lowered position “B” of the up-down carriage 20. As is apparent in FIG. 1, the restrictor means includes a limit switch 12 affixed to the changer frame portion 10 of the machine frame 1 and a dog member 24 attached to the up-down carriage 20 at such a position that the limit switch 12 is activated by the dog member 24 at the end of descending movement of the up-down carriage 20. When activated by the dog member 24, the limit switch 12 enables a typical control circuit(not shown) to have the vertical magazine actuator 30 cease from further operation, thus ensuring that the up-down carriage 20 can stop at the lowered position “B”. It should be noted that the lowered position “B” may be any suitable position that allows easy removal of a tool from the spindle 3.

Turning back to FIG. 1, the automatic tool changer in accordance with the present invention is provided with a magazine carriage 40 laterally movably mounted to the up-down carriage 20 and a horizontal magazine actuator 50 for causing the magazine carriage 40 to move in a generally horizontal direction. The magazine carriage 40 is placed at the lower end of the up-down carriage 20 in such a manner that it can move in a generally horizontal direction along a guide bar 42 forming a part of the up-down carriage 20. The magazine carriage 40 can be moved between an operative position “C” close to the spindle 3 as indicated in phantom and a home position “D” far away from the spindle 3 as illustrated in solid lines lines in FIG. 1. As clearly shown in FIG. 2, the guide bar 42 is provided in pair and adapted to make sliding engagement with the sleeves 44 of the magazine carriage 40 at two locations.

Preferably, the horizontal magazine actuator 50 is a pneumatic cylinder and has a cylinder housing 52 and a cylinder rod 54 extendibly fitted with each other. The cylinder housing 52 is fixedly mounted to the up-down carriage 20 whereas the cylinder rod 54 is connected to the magazine carriage 40 at its free end. The horizontal magazine actuator 50 can be subjected to extending and retracting movement to thereby reciprocate the magazine carriage 40 between the operative position “C” and the home position “D”.

In the meantime, the automatic tool changer according to the invention further includes a lateral movement stopper means for determining the operative position “C” of the magazine carriage 40. In the illustrated embodiment, the stopper means comprises a limit switch 26 affixed to the up-down carriage 20 at such a position that the limit switch is directly activated by the magazine carriage 40 at a predetermined moment. When activated by the magazine carriage 40, the limit switch 26 enables a typical control circuit(not shown) to have the horizontal magazine actuator 50 cease from further operation, thereby making sure that the magazine carriage 40 can stop at the operative position “C”.

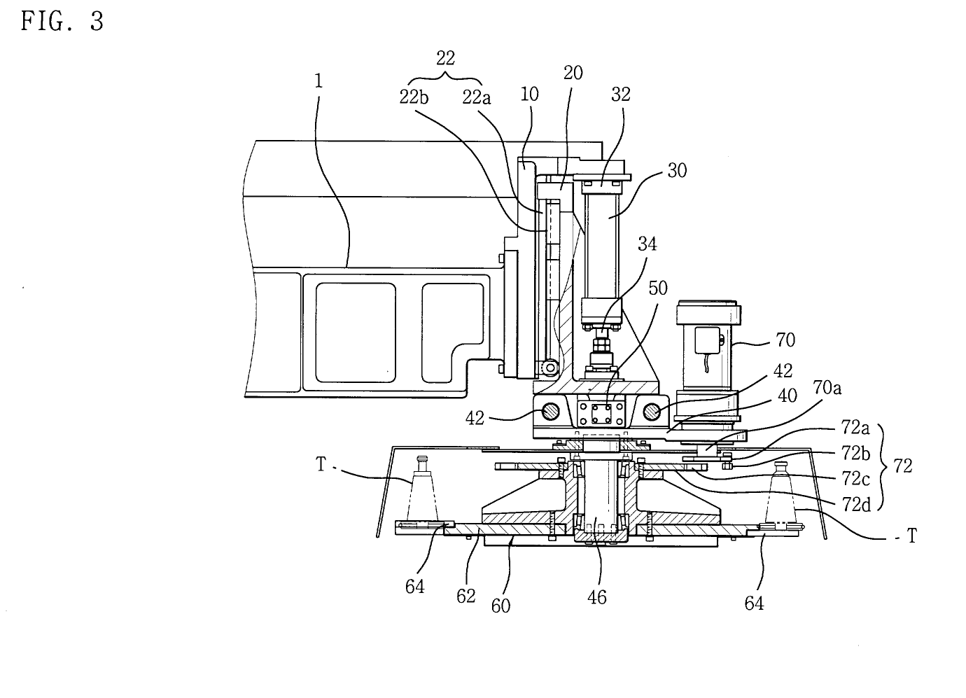

It will be seen in FIGS. 1 and 3 that a tool storage magazine 60 is mounted to the magazine carriage 40 for rotation about a generally vertical axis by means of a rotary driver means stated hereinbelow. The tool storage magazine 60 is rotatably fitted to a shaft 46 that depends from the magazine carriage 40 and has a support wheel 62, along the circumferential periphery of which a plurality of tool holders 64 for changeably holding different kinds of tools “T” are arranged at an equal spacing. Each of the tool holders 64 is provided with a pair of resiliently yieldable fingers 66 that can cooperate with each other to releasably grip the respective one of the tools “T”.

The tool storage magazine 60 of such construction will be able to carry the tools “T” of many different kinds and may be caused to rotate about the shaft 46. Particularly, the tool storage magazine 60 can move upwards and downwards together with the up-down carriage 20 as the up-down carriage 20 is subjected to sliding movement from the raised position “A” into the lowered position “B” and vice versa. On the other hand, lateral movement of the magazine carriage 40 from the home position “D” into the operative position “C” and vice versa will cause the tool storage magazine 60 to move toward and away from the spindle 3.

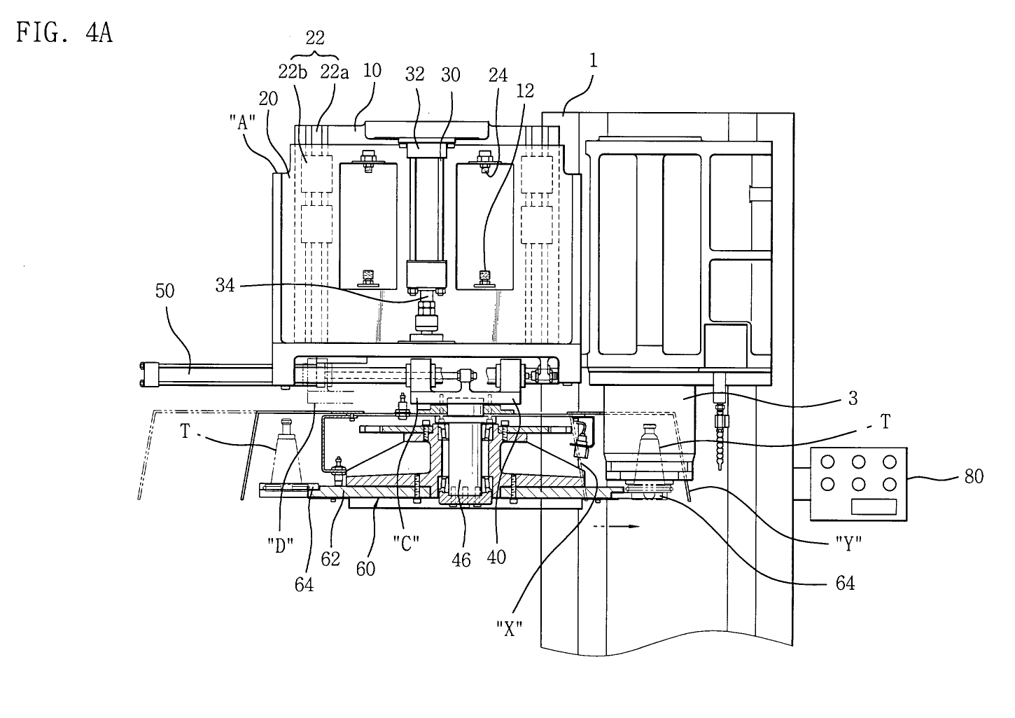

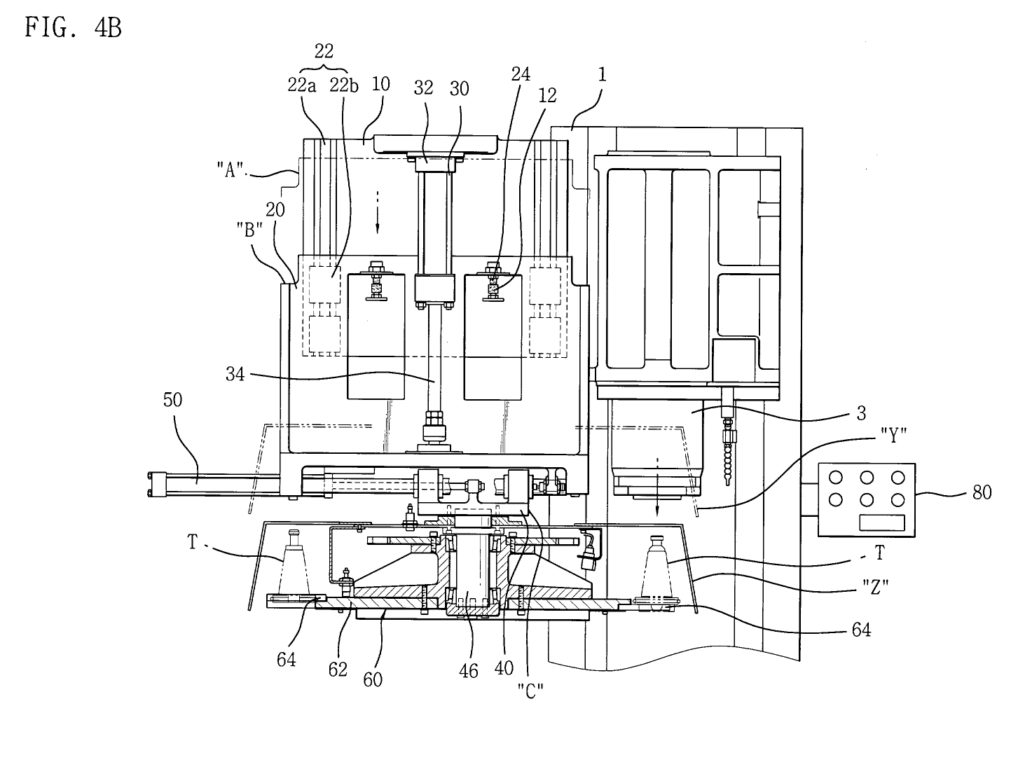

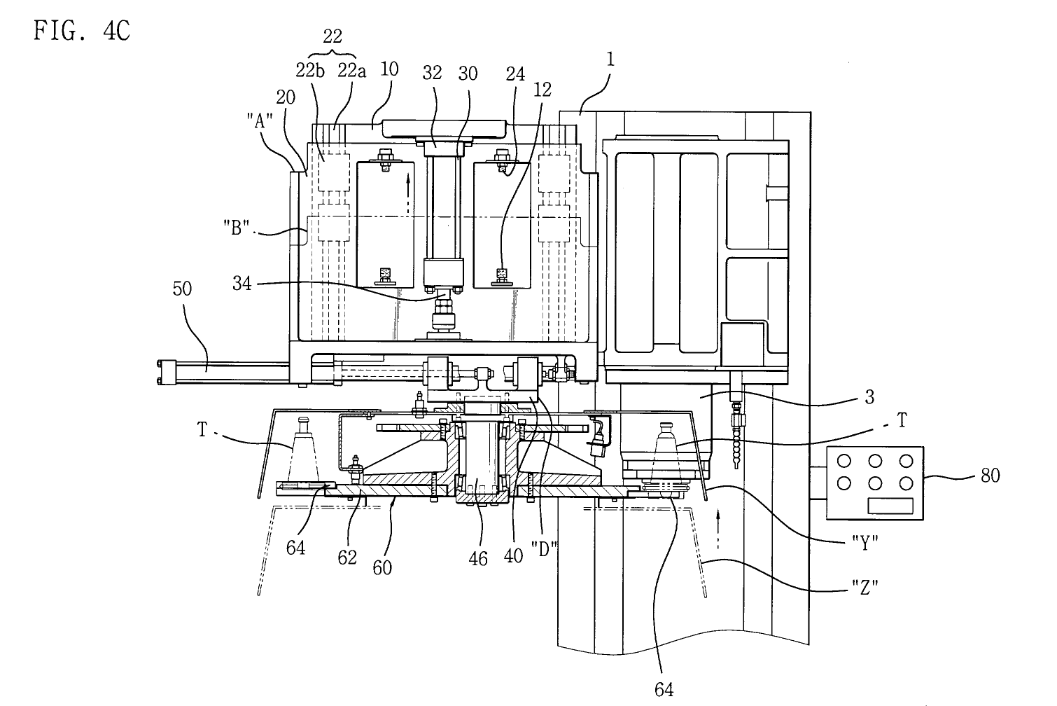

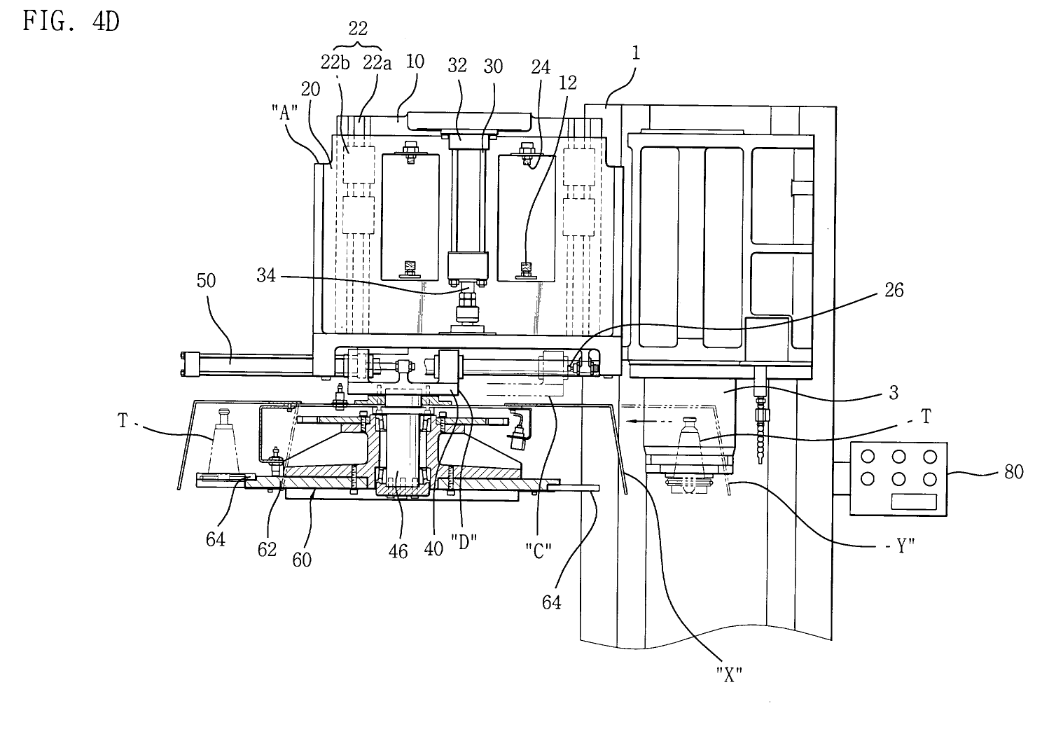

More specifically, if the magazine carriage 40 is moved from the home position “D” toward the operative position “C” with the up-down carriage 20 placed in the raised position “A” as illustrated in FIG. 4A, the tool storage magazine 60 will be brought from a first position “X” into a second position “Y” to thereby grip the tool “T” held in the spindle 3. Under this situation, descending movement of the up-down carriage 20 into the lowered position “B” will cause the tool storage magazine 60 to move from the second position “Y” into a third position “Z” as indicated in FIG. 4B, as a result of which the tool “T” is forcedly removed out of the spindle 3. To the contrary, ascending movement of the up-down carriage 20 from the lowered position “B” into the raised position “A” will bring the tool storage magazine 60 from the third position “Z” back to the second position “Y” as indicated in FIG. 4C, assuring that the tool “T” comes into engagement with the spindle 3. If the magazine carriage 40 is returned back to the home position “D” from the operative position “C” with the up-down carriage 20 lying in the raised position “A” as shown in FIG. 4D, the tool storage magazine 60 is shifted from the second position “Y” to the first position “X” so that the tool holder 64 can release the tool “T” in the spindle 3.

As best shown in FIG. 3, the automatic tool changer further includes a rotary driver means for causing the tool storage magazine 60 to rotate in a manner that a selected one of the tools “T” in the tool storage magazine 60 can come into alignment with the spindle 3. The rotary driver means comprises an electric motor 70 fixedly mounted to the magazine carriage 40 and a geneva mechanism 72 for intermittently coupling rotational forces of the electric motor 70 to the tool storage magazine 60. The geneva mechanism 72 comprises a driver plate 72a secured to an output shaft 70a of the electric motor 70, an eccentric pin 72b fixedly attached to the driver plate 72a, and a driven plate 72d having a plurality of open-ended radial slots 72c each engageable with the eccentric pin 72b as the driver plate 72a is subjected to rotating movement. The geneva mechanism 72 makes it sure that the tool storage magazine 60 is rotated by a predetermined angle at one time so that a selected one of the tools “T” in the tool storage magazine 60 can be brought into alignment with the spindle 3 while the magazine carriage 40 remains in the operative position “C”.

Referring again to FIG. 1, the automatic tool changer is provided with an electronic control part 80 that, in response to a tool change command, serves to cause extending movement of the horizontal magazine actuator 50 to thereby bring the magazine carriage 40 into the operative position “C”. Then the control part 80 will cause extending movement of the vertical magazine actuator 30 so that the up-down carriage 20 can be moved from the raised position “A” into the lowered position “B”. The electric motor 70 is subsequently energized to have the tool storage magazine 60 rotate at a given angle. At the termination of rotation of the tool storage magazine 60, the vertical magazine actuator 30 is retracted to bring the up-down carriage 20 into the raised position “A”, after which the magazine carriage 40 is returned back to the home position “D” by virtue of retracting movement of the horizontal magazine actuator 50.

In other words, the control part 80 functions to operate the horizontal magazine actuator 50, the vertical magazine actuator 30 and the electric motor 70 in a predetermined sequence, whereby the tool storage magazine 60 is moved from the first position “X” to the second position “Y” and then the third position “Z” where the stepwise rotation of the tool storage magazine 60 takes place, and thereafter is returned back to the first position “X” via the second position “Y”.

Operation of the automatic tool changer in accordance with the present invention will be set forth as a whole with particular reference to FIGS. 1 and 4A through 4D.

At an initial step, a tool change command is issued to the control part 80 under the condition that the up-down carriage 20 lies in the raised position “A” with the magazine carriage 40 placed in the home position “D” as shown in FIG. 1, the horizontal magazine actuator 50 is caused to extend, as illustrated in FIG. 4A, to bring the magazine carriage 40 into the operative position “C” out of the home position “D”. As the magazine carriage 40 moves toward the operative position “C”, the tool storage magazine 60 mounted thereto is shifted from the first position “X” into the second position “Y” so that the tool holder 64 can grip the tool “T” held by the spindle 3.

Once the tool gripping operation is completed, the vertical magazine actuator 30 is extended, as noted in FIG. 4B, to thereby bring the up-down carriage 20 into the lowered position “B”. Such descending movement of the up-down carriage 20 will cause the tool storage magazine 60 to be lowered from the second position “Y” into the third position “Z”, thus resulting in the tool “T” being removed from the spindle 3.

As soon as removal of the tool “T” is accomplished, the electric motor 70 will be energized to have the tool storage magazine 60 rotated into a predetermined angular position. This assures that one of the tools to be changed come into exact alignment with the spindle 3. At the end of such tool aligning operation, the vertical magazine actuator 30 is caused to retract, as can be seen in FIG. 4C, in order to bring the up-down carriage 20 into the raised position “A”. Such ascending movement of the up-down carriage 20 will cause the tool storage magazine 60 to move into the second position “Y”, thus bringing the selected tool in the tool holder 64 into engagement with the spindle 3.

Just after the tool “T” is tranferred to the spindle 3, the horizontal magazine actuator 50 is caused to retract, as confirmed in FIG. 4D, to have the magazine carriage 40 returned back to the home position “D”. This will cause the tool storage magazine 60 to move into the first position “X”, thereby releasing the tool “T” in the spindle 3. Through this series of consecutive operations, the tool in the tool storage magazine 60 can be changed with the one in the spindle 3 in a fully automated manner.

As set forth hereinabove, the automatic tool changer according to the invention has the ability to accomplish the tool changing operation without having to use any tool change arm and with no need to cause positive movement of the spindle. This help reduce the overall length of a machine frame, while assuring an increased degree of precision in cutting a workpiece.

Although one preferred embodiment of the present invention has been shown and described for illustrative purposes, those skilled in the art will appreciate that various modifications, additions and substitutions are possible without departing from the scope and spirit of the invention as disclosed in the accompanying claims.

What is claimed is:

1. An automatic tool changer for machine tool, comprising:
a machine frame with a lateral changer frame portion;
a spindle rotatably attached to the machine frame and adapted to removably hold a tool in position;
an up-down carriage mounted to the changer frame for elevational movement between a raised position and a lowered position;
a magazine carriage laterally movably mounted to the up-down carriage for movement between a home position far away from the spindle and an operative position close to the spindle;
a tool storage magazine carried by the magazine carriage and having a plurality of tool holders for changeably holding different kinds of tools;
a vertical magazine actuator for causing the up-down carriage, the magazine carriage and the tool storage magazine to move as a unit in a generally vertical direction in such a manner that one of the tools can be either brought into engagement with the spindle or removed from the spindle; and
a horizontal magazine actuator for causing the magazine carriage and the tool storage magazine to move in a generally horizontal direction toward or away from the spindle so that one of the tool holders can either grasp or release the tool in the spindle.

2. The automatic tool changer for machine tool as recited in claim 1, further comprising a rotary driver means for causing the tool storage magazine to rotate so that a selected one of the tools in the tool storage magazine can come into alignment with the spindle when the magazine carriage is in the operative position

3. The automatic tool changer for machine tool as recited in claim 2, wherein the rotary driver means comprises an electric motor and a geneva mechanism for intermittently coupling rotational forces of the electric motor to the tool storage magazine to cause rotation of the magazine.

4. The automatic tool changer for machine tool as recited in claim 3, wherein the geneva mechanism comprises a driver plate mounted to an output shaft of the electric motor, an eccentric pin fixedly secured to the driver plate, and a driven plate having a plurality of open-ended radial slots each engageable with the eccentric pin as the driver plate is subjected to rotating movement.

5. The automatic tool changer for machine tool as recited in claim 1, further comprising a descending movement restrictor means for determining the lowered position of the up-down carriage, the restrictor means including a limit switch affixed to the changer frame portion of the machine frame and a dog member attached to the up-down carriage at such a position that the limit switch is activated by the dog member at the moment when one of the tool holders in the tool storage magazine removes the tool out of the spindle completely.

6. The automatic tool changer for machine tool as recited in claim 1, further comprising a lateral movement stopper means for determining the operative position of the magazine carriage, the stopper means including a limit switch affixed to the up-down carriage at such a position that the limit switch is directly activated by the magazine carriage at the moment when one of the tool holders in the tool storage magazine comes into engagement with the tool held in the spindle.

7. The automatic tool changer for machine tool as recited in claim 1, wherein the up-down carriage is slidably mounted to the changer frame portion of the machine frame by means of a linear motion guide extending in a parallel relationship with respect to the spindle.
